(19) United States
(12) Patent Application Publication
(10) Pub. No.: US 2025/0319449 A1
(43) Pub. Date: Oct. 16, 2025

(54) MICROWAVE-HEATED FLUIDIZED BED REACTOR

(71) Applicant: Cecilia Energy, Inc., Newark, NJ (US)

(72) Inventors: Robert WEISS, San Francisco, CA (US); Alex WELSH, San Francisco, CA (US); Robert BARNUM, The Woodlands, TX (US); Yu-Ting CHENG, Whippany, NJ (US); Kathryn CARPENTER, Brooklyn, NY (US); Anthony MEGALLA, Jersey City, NJ (US)

(21) Appl. No.: 19/179,692

(22) Filed: Apr. 15, 2025

Related U.S. Application Data
(60) Provisional application No. 63/634,916, filed on Apr. 16, 2024.

(51) Int. Cl. B01J 6/00; C01B 3/02; C01B 32/16

(52) U.S. Cl. CPC B01J 6/008; C01B 3/02; C01B 32/16

(57) ABSTRACT

A reactor including a vertically oriented vessel with a gas inlet port, a distributor, a feedstock port, and a microwave generator. The reactor is designed to process a carbon feedstock to produce hydrogen gas and a hydrogen deficient carbon product, utilizing a fluidized bed provided with microwave energy. Also disclosed are methods of converting a carbon feedstock, particularly a solid carbon feedstock, into hydrogen gas and a hydrogen deficient carbon product, preferably including carbon nanotubes.

### CROSS-REFERENCE TO RELATED APPLICATION

This application is related to and claims priority under 35 U.S.C. § 119 (c) from U.S. Provisional Application No. 63/634,916 filed Apr. 16, 2024, titled “Microwave-Heated Fluidized Bed Reactor,” the entire contents of which is incorporated herein by reference for all purposes.

### BACKGROUND

Recent times have exacerbated another pandemic we are in-waste plastic pollution. This pandemic is one that is set to increase exponentially over time unless there is a radical shift in the definition and capabilities of recycling. The worldwide production of human-made plastic is currently more than 330 million tons per year, with production of plastic waste anticipated to increase at an estimated 3.9% per year. (Fivga, A. & Dimitriou, I. Energy 149, 865-874 2018.) Given the rate of current production and use of plastic, it is estimated that approximately 12 trillion tons of plastic waste will require disposal by 2050. (Geyer, R., Jambeck, J. R. & Law, K. L. Sci. Adv. 3, 2017.)

Currently, the vast majority of plastics are landfilled or incinerated, with only a small proportion recycled. (Chen, X., Wang, Y. & Zhang, L. ChemSusChem 14, 4137-4151 2021.) Landfilling is unsustainable at the current rate of plastic waste production, and also fails to extract energy or useful products from this abundant carbon-containing feedstock. Incineration is a fairly inefficient method of energy extraction, and can also cause pollution and produce carbon dioxide, thereby exacerbating climate change.

Plastic recycling is only available for some thermoplastics, primarily the polyolefins polyethylene and polypropylene. (Chen, X., Wang, Y. & Zhang, L. ChemSusChem 14, 4137 4151 2021; Solis, M. & Silveira, S. Waste Manag. 105, 128-138, 2020.) However, thermoplastic recycling leads to a reduction in strength and resiliency, resulting in a downcycling of products that cost more to produce than virgin plastic. (Ibid.)

Due to limitations in current recycling methods, researchers have turned to plastic upcycling technologies. Plastic upcycling strategies largely fall into one of two categories: (1) thermochemical degradation to produce gases and/or petroleum-like oils, or (2) degradation of the plastic polymer to generate monomers, which then undergo polymerization to produce plastics of similar mechanical and structural properties as virgin plastics. Most thermochemical degradation methods are classified as either pyrolysis or gasification technologies. (Nanda, S. & Berruti, F. Environ. Chem. Lett. 2020 191 19, 123-148 2020.)

Pyrolysis techniques generally have higher conversion efficiencies and lower costs compared to gasification, but the choice largely comes down to what the desired products are. Hydrocarbons are produced in both pyrolysis and gasification technologies and can then be used to synthesize a wide range of desirable chemicals and fuels.

Microwave (MW)-assisted thermo-catalytic decomposition of plastics is much more energy efficient than current thermal and thermo-catalytic technologies. To date, however, MW-assisted thermo-catalytic decomposition has been used in the production of pyrolytic oils.

MW-assisted thermo-catalysis has been applied to produce hydrogen and carbon from plastics, achieving ˜90% yield of H2. (Jie, X. et al., “Microwave-initiated catalytic deconstruction of plastic waste into hydrogen and high-value carbons”, Nat Catal 3, 902-912, 2020.) However, this process relies upon continuous re-cracking over an extended time period, e.g., about an hour, of liquids and gases under high MW power to achieve these yields. These conditions require a high energy consumption and as such, preclude economic scaling. In addition, this is a batch process and requires a long processing time.

In view of the above, there exists a need for methods, devices, and systems capable of reducing the amount of waste plastic globally. Moreover, it will become apparent that there is need for efficient generation of hydrogen gas and other products from available carbon feedstocks of various sorts.

Citation of any reference in this section is not to be construed as an admission that such reference is prior art to the present disclosure.

### BRIEF DESCRIPTION OF THE DRAWINGS

FIG. 1 illustrates a reactor according to one embodiment of the present disclosure.

FIG. 2 illustrates a reactor according to one embodiment of the present disclosure.

FIG. 3A illustrates a lower portion of a reactor according to one embodiment of the present disclosure.

FIG. 3B illustrates an upper portion of a reactor according to one embodiment of the present disclosure.

FIG. 4 illustrates a flow chart in accordance with one embodiment of the disclosed methods.

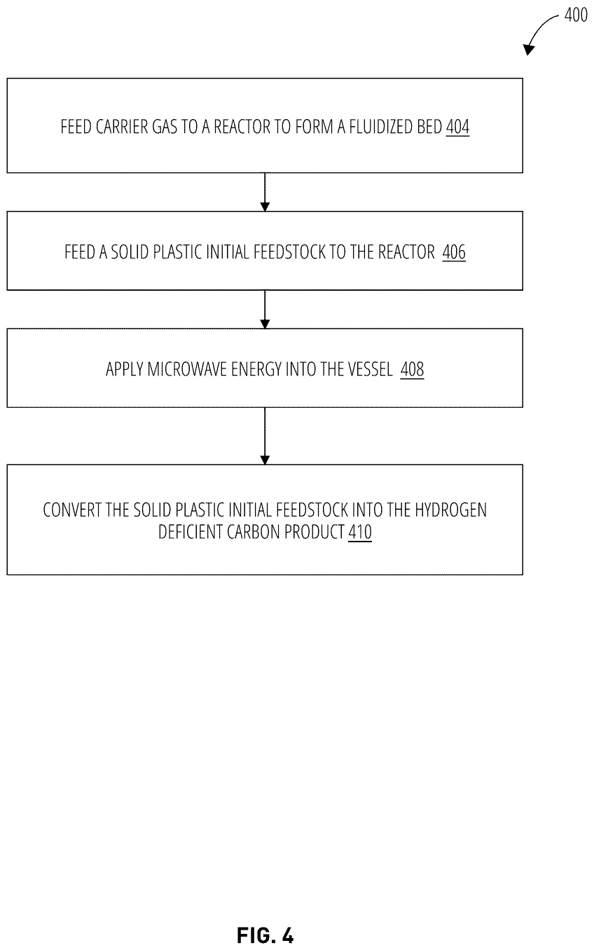

### BRIEF SUMMARY

Aspects of the present disclosure provide a microwave-heated fluidized bed reactor configured to convert hydrocarbon feedstocks into hydrogen deficient carbon products and/or hydrogen gas, and methods of converting hydrocarbon feedstocks into hydrogen deficient carbon products and/or hydrogen gas.

According to some preferred embodiments, the disclosed reactors and methods may be configured to convert solid plastic feedstocks to hydrogen deficient carbon products including carbon nanotubes (“CNTs”). According to some aspects the disclosed reactors and methods provide for a continuous flow process for conversion of solid hydrocarbon feedstocks into hydrogen deficient carbon products.

Some aspects of the present disclosure provide a reactor including: a vertically oriented vessel including a gas inlet port configured to provide a carrier gas to an interior of the vessel; a distributor operably coupled with a lower portion of the vessel, the distributor adapted to distribute the carrier gas into the interior of the lower portion of the vessel; a feedstock port arranged to continuously provide a carbon feedstock into the interior of the vessel; and a microwave generator operably coupled with the vessel and configured to inject microwave energy into the interior of the vessel. According to some embodiments, the vessel may be cylindrical and/or may contain a fluidized bed.

Additionally, some aspects of the present disclosure provide a method of producing a hydrogen deficient carbon product, including: providing a reactor having a vertically oriented vessel including a gas inlet port configured to provide a carrier gas to an interior of the vessel, a distributor operably coupled with a lower portion of the vessel, the distributor adapted to distribute the carrier gas into the interior of the lower portion of the vessel, a feedstock port arranged to continuously provide a carbon feedstock into the interior of the vessel, and a microwave generator operably coupled with the vessel and configured to inject microwave energy into the interior of the vessel; feeding the carrier gas to the reactor via the gas inlet port, to form a fluidized bed; feeding a solid plastic initial feedstock to the reactor via the feedstock port; applying microwave energy into the vessel using the microwave generator; and converting the solid plastic initial feedstock into the hydrogen deficient carbon product.

### DETAILED DESCRIPTION

Aspects of the present disclosure include methods of producing hydrogen deficient carbon products from hydrocarbon containing, or more generally carbon containing, feedstocks, and a microwave-assisted fluidized bed reactor for the same. In some aspects, the system may also produce hydrogen gas. In some arrangements discussed herein, the feedstock may be plastic, such as waste plastic, but the disclosed methods and systems are not limited to processing plastic feedstocks. In a preferred embodiment, the feedstock is a solid plastic feedstock and is converted directly from solid form into a hydrogen deficient carbon product in the disclosed reactor. In some aspects, the hydrogen deficient carbon may be in solid form and may include CNTs.

As used herein, “aperture” refers to a hole, opening, perforation, or the like, which extends all the way through a material, surface, or component.

As used herein, “carbon feedstock” refers to a material rich in carbon used as a raw source for the disclosed reactions.

As used herein, “effluent stream” refers to an output stream of the disclosed reactor.

As used herein, “initial feedstock” refers to the material which serves as the reactant in the disclosed reactions and methods, and which has not previously been part of an effluent stream of the disclosed reactor. As used herein, “feed stream” refers to an input stream to the disclosed reactor. The disclosed feedstock may be included in a feed stream, along with additional materials other than the feedstock (e.g. solvents, carriers, catalysts, etc.). As used herein, “recycled feedstock” refers to the material which serves as the reactant in the disclosed reactions and methods, and which has previously been part of an effluent stream of the disclosed reactor. As used herein “feedstock” may refer to either initial or recycled feedstocks. As used herein, “initial” generally refers to a stream which is introduced into the reactor for the first time, while “recycled” generally refers to a stream which is being returned to the reactor.

As used herein, “lower portion” refers to a portion closer to the lowest end of an object in the vertical direction than to the uppermost end of the object in the vertical direction. “Upper portion” refers to a portion of an object closer to the uppermost end in the vertical direction than to the lowermost end of the object in the vertical direction.

As used herein, “hydrogen deficient carbon product” refers to a solid carbon product of the disclosed methods and reactions, e.g. graphite, graphene, carbon nanotubes (“CNTs”), amorphous carbon, carbon black, fullerenes, carbon fiber, glassy carbon, and the like, and mixtures thereof. As used herein, “hydrogen deficient carbon product” does not include liquid hydrocarbons.

As used herein, “vertical” refers to a directional orientation that is perpendicular to the horizon and typically aligns with the direction of gravity. “Upper,” “higher,” “top,” “above,” and the like refer to positions further away from the earth's gravitational source and/or to the horizon. Conversely, “lower,” “bottom,” “below,” and the like refer to positions closer to the earth's gravitational source and/or to the horizon.

The microwave-assisted fluidized bed reactor involves a fluidized bed reactor vessel for processing feedstock. The feedstock may be mixed with a catalyst to form a mixture within the reactor vessel. The catalyst may be a microwave absorber that heats when exposed to the microwave energy and/or the mixture may further include a distinct absorber.

The microwave-assisted fluidized bed reactor involves a fluidized bed reactor vessel for processing feedstock. The fluidized bed described in the examples herein is an upflow bed but the fluidized beds may also be circulating or bubbling. The feedstock may be mixed with a catalyst to form a mixture within the reactor vessel. The catalyst may be a microwave absorber that heats when exposed to the microwave energy and/or the mixture may further include a distinct absorber.

According to aspects of the disclosed methods, a carrier gas is injected into the vessel at sufficient velocity to suspend the feedstock and catalyst within the vessel—referred to as fluidization. The feedstock will be fluidized with the catalyst and/or absorber when either or both are present. Microwave energy is then directed into the vessel to heat the mixture. The catalyst and/or the absorber will be selectively heated by the microwaves, which will carry heat to the feedstock. In some instances, the feedstock will directly absorb microwaves and an absorber or catalyst may not be required. The direct or indirect heating of the feedstock may release nitrogen gas from the feedstock and/or produce hydrogen deficient carbon products.

The reactors and methods disclosed herein may be used to process many different feedstocks, and generally speaking anything that that can be disintegrated/broken down by pyrolysis, including, but not limited to: plastics; other hydrocarbons, such as, but not limited to natural gas, liquefied petroleum gas, petroleum distillates, petroleum oils; carbohydrates and other biomass such as wood chips, plant wastes, etc; and, any other similar solid, liquid, or gas material that can be broken down by pyrolysis. As such, while waste plastic may be processed to produce hydrogen deficient carbon with benefits to the environment while also producing hydrogen gas. In some aspects, the disclosed reactors and methods are adapted to accept solid initial feedstocks. In some preferred embodiments, the solid initial feedstocks include or consist of waste plastic. The system is also suitable for a host of other beneficial processes, which may similarly produce hydrogen gas among other products as discussed herein.

The disclosed methods and fluidized bed reactors are advantageous in that they may convert feedstocks into hydrogen deficient carbon products and hydrogen gas in a relatively short time as compared to batch processes. The disclosed flow processes and fluidized bed system may be run continuously injecting feedstock and converting the feedstock, which allows for relatively larger through-put and scale. This also overcomes the limitations of utilizing microwaves in conventional batch processes, which include uneven heating and reaction rates as a result of lack of penetration depth and non-uniform heating profiles.

Further, in aspects where the initial feedstock includes a solid plastic and the hydrogen deficient carbon product includes carbon nanotubes, the disclosed methods and fluidized bed reactors are advantageous in that they may convert the solid initial feedstock directly into useful hydrogen deficient carbon products including carbon nanotubes. In contrast, conventional processes require one or more intermediate steps, e.g., melting plastics into liquid hydrocarbon, vaporizing liquid hydrocarbons or other carbon sources, and producing solid CNTs from carbon containing vapor. Further, without wishing to be bound by theory, the use of a fluidized bed in the disclosed reactors and methods, allows for production of a product stream having advantageously increased levels of solid hydrogen deficient carbons, as opposed to product streams from conventional methods and reactors (including reactors utilizing fixed beds) which may tend to produced largely liquid hydrocarbon products. In particular, the disclosed methods and reactors utilizing fluidized beds may allow for the production of solid hydrogen deficient carbon products which include CNTs and CNT/graphite mixtures.

Microwave energy can be transferred directly into a material as the electromagnetic field couples into the target material. Effectively, the target material (e.g., the catalyst and/or the absorber when the initial feedstock is plastic or other such transparent feedstocks), becomes the heater element. Not all materials, such as many plastics, are well heated by microwaves, but for materials that can absorb microwave energy and convert it to heat—generally, non-conductive materials composed of polar molecules—microwave heating is very efficient. Plastic feedstock, which may be processed in various aspects of the present disclosure, is often transparent to microwaves, and thus heated indirectly via a catalyst or absorber absorbing the microwaves. In some embodiments, however, the feedstock itself may be microwave absorbing. Accordingly, the disclosed methods and reactions may or may not involve a catalyst and/or absorber. In some examples, an absorbent feedstock may be mixed with a non-absorbent feedstock with the absorbent feedstock also acting as an absorber and transferring heat to the non-absorbent feedstock.

Microwave heating has the additional advantage over traditional heating of being volumetric. While the target material heated by conduction or radiation from a heater clement is heated only on its outer surface and then conducts heat to its interior, the target material heated by microwaves can be directly heated below its surface. Microwaves penetrate the target material and create heat directly on the target surface and as well as in the target's interior. The extent to which the interior of a target material is heated by microwaves is dependent on the “lossiness” of the target. A target material that is highly effective at absorbing microwaves is referred to as “high loss” because impinging microwave radiation quickly gives up its energy to the target material. Conversely, a target material which does not absorb microwaves effectively is referred to as “low loss.” High loss materials heat quickly but only close to their surface. In such materials, microwave energy is fully absorbed before they can penetrate deeply into the material. The depth to which the microwave penetrates a material is called the penetration depth. When heating high loss materials with low penetration depth, energy efficiency is excellent, but thermal uniformity of the material is compromised.

Aspects of the present disclosure involve a microwave-assisted fluid bed reactor and methods of using the same, that may optimize thermal uniformity while maintaining high energy efficiency. As disclosed, a fluidized bed reactor (FBR) is used herein to achieve thermal uniformity in a microwave reactor when processing various possible hydrocarbon or carbon feedstocks. For example, an FBR may be used to achieve thermal uniformity in a microwave reactor when processing either high or low loss materials. In a further embodiments, the excellent heat exchange between the low loss solid plastic feedstock materials, for example, and the high loss absorbers and/or catalysts, as well as heat exchange between catalyst and absorbers, of a fluidized bed results in substantially uniform temperature of materials in the bed even under conditions where the penetration depth is very limited by the minimal penetration depth of the microwave energy.

While the heat transfer of a fluidized bed results in thermal uniformity when heating with microwaves, a bed with high loss, low penetration depth materials may experience a non-uniform electro-magnetic (EM) field strength. For many processes, the benefits of microwave heating—speed, efficiency, selectivity—are achieved with an FBR with non-uniform microwave field. However, some processes that are thermally driven are also enhanced by the presence of the EM field. For field-enhanced processes, uniformity of the field is important. Accordingly, the present disclosure provides a microwave assisted fluidized bed reactor and methods of using the same, that addresses high loss materials in the bed with shallow penetration of the field and poor uniformity.

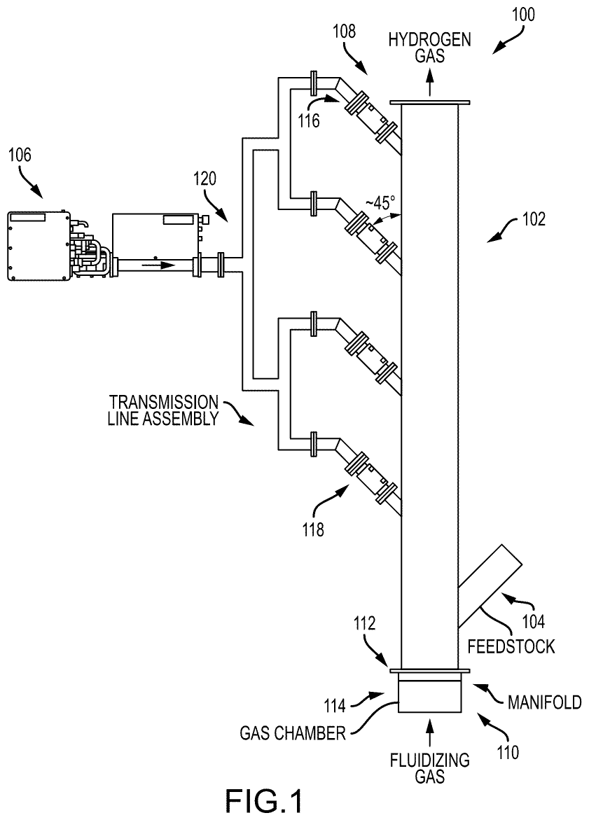

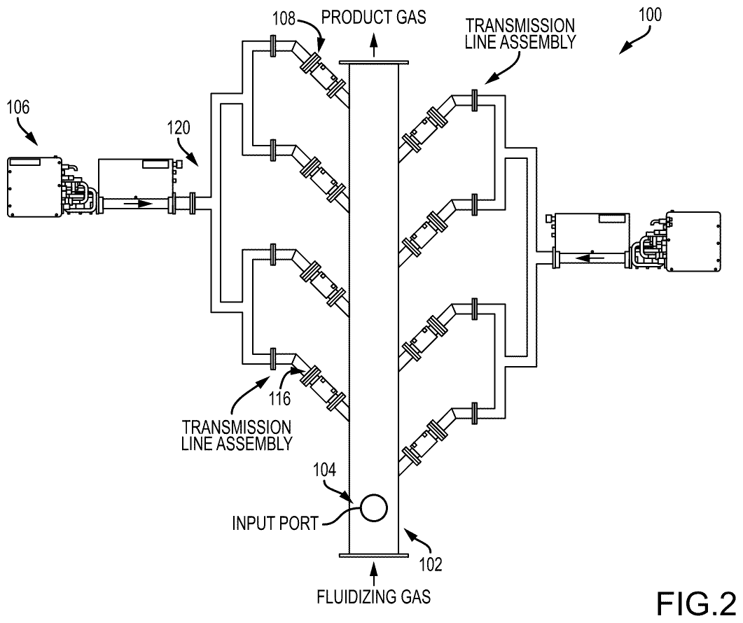

FIG. 1 illustrates a first example of a microwave-assisted/heated fluidized bed reactor 100 according to aspects of the present disclosure. FIG. 2 illustrates a second example of a microwave-assisted/heated fluidized bed reactor 100 according to aspects of the present disclosure. The two examples include various features in common as well as distinctions.

To begin, each example includes a reactor vessel 102. The reactor vessel 102 may include a cylindrical body, as shown, but may include other cross-sectional shapes such as a triangle, square or rectangle in various possible examples. In the cylindrical version illustrated, the diameter may be within the range of 1 inch to 48 inches, more preferably 6 inches to 30 inches, and most preferably 10 inches to 20 inches. However, other diameters are possible, with a 12 inch diameter vessel being one specific example. Diameter of the vessel is important in ensuring successful fluidization of the bed based on flow rates of feedstock, catalyst, and carrier gas. Further the cylindrical shape of the vessel 102 may contribute to successful distribution of microwave energy within the vessel so as to achieve appropriate heating and conversion of the feedstock into the hydrogen deficient carbon product—as opposed to inefficient conversion and/or conversion into liquid hydrocarbons, as in many conventional processes.

The vessel 102 may include, or may be entirely formed of, stainless steel or other material sufficient to withstand the temperature of the reactions occurring within the chamber as well as being inert to the chemical reactions taking place in the interior of the reactor. While methods of producing hydrogen deficient carbon products and/or hydrogen gas from plastic are discussed herein, other feedstock and processing reactions may be practiced within the vessel 102, and the vessel 102 material may depend on such different possible temperatures and chemical reactions (including catalysts and absorbers that may be used).

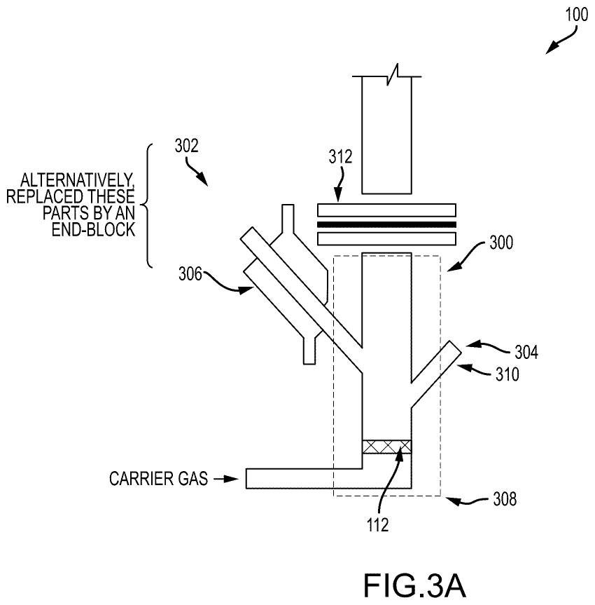

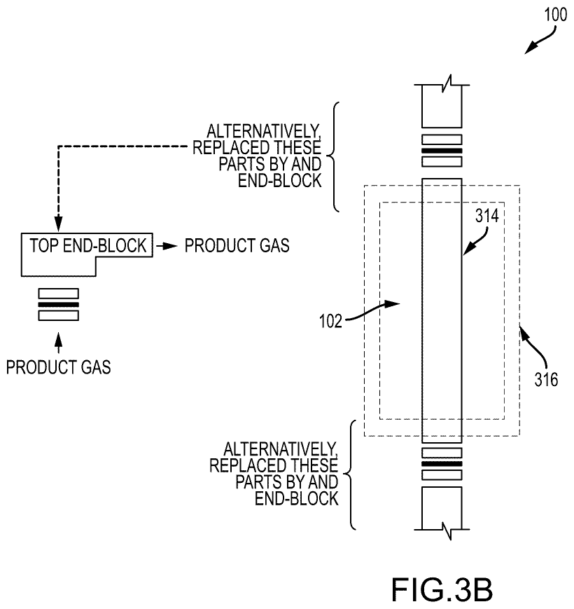

While not shown, the vessel 102 may be insulated. It is also possible to apply some source of external heat to the vessel housing, such as may be involved in some sort of preprocessing step (see, e.g., FIG. 3 discussed below) or to help with thermal uniformity. The vessel 102 may also be quartz lined or have a quartz window, and may include any other MW transparent materials as liner materials and/or windows. If lined with quartz or any other MW transparent liner, it is also possible to include insulation between the lining and the outer shell. The vessel 102 may also be adapted to be pressurized or maintained under vacuum, and the disclosed methods may be conducted in a pressurized reactor or a reactor under vacuum conditions.

The feedstock converted in the disclosed methods and reacted in the vessel 102 may be of many forms. In one example of the disclosed methods of processing plastic feedstock, the plastic may be considered mixed plastic waste, e.g. from a hospital waste, collected from oceans and other bodies of water or waterways, and/or retrieved from waste generated by aerospace products and operations. In different respects, the plastic may include or may be selected from the group consisting of polypropylene (PP), polycarbonate (PC), polystyrene (PS), polyethylene (PE), (such as low-density polyethylene (LDPE) and high-density polyethylene (HDPE), polyvinyl chloride (PVC), acrylonitrile-butadiene-styrene (ABS), polyethylene terephthalate (PET), nylon, and polyamides, and combinations thereof. In some aspects, the plastic is one or more materials selected from the group consisting of HDPE, PP, PET, PS, and LDPE. The plastic may also be two or more materials selected from the group consisting of HDPE, PP, PET, PS, and LDPE; three or more materials selected from the group consisting of HDPE, PP, PET, PS, and LDPE and/or four or more materials selected from the group consisting of HDPE, PP, PET, PS, and LDPE, and various combinations. In some embodiments, the initial feedstock is a plastic initial feedstock and in a preferred embodiment, the feedstock includes or is entirely a solid plastic feedstock.

The feedstock, whether plastic or otherwise, may be unsorted, sorted, treated, or untreated. In embodiments using a solid initial feedstock, the feedstock may also be subjected to pre-treatment including one or more of a washing process, a drying process, and a size modification process. The size modification may include one or more of shredding, grinding, pelleting, beading, and/or any other appropriate methods of modification of size or form, such as from an original form. In some embodiments, the size modification includes grinding, preferably by mechanical or cryogenic processes. In some embodiments, the size modification produces a particulate initial feedstock with a particle size of 13 mm or less, 10 mm or less, 5 mm or less, 1.0 mm or less, 0.75 mm or less, more preferably 0.5 mm or less, and most preferably 0.25 mm or less. In some embodiments, the initial feedstock may have a particle size of 0.1 mm or more, 0.2 mm or more, 0.5 mm or more, or 1.0 mm or more. Providing feedstock with an appropriate particle size may be important to allow for fluidization and appropriate operation of the reactor bed. For example, incorrect feedstock size, either too large or too small, may cause inconsistent feeding, defluidization of catalyst bed, incomplete reaction, etc.

While in preferred embodiments the initial feedstock is primarily (e.g. at least 90 wt %, at least 95 wt %, or at least 99 wt %) or entirely (100 wt %) solid, it may also include liquid materials as well as combinations of liquid and solid materials. In addition, the initial feedstock may be included within a feed stream fed to the reactor 100. In some embodiments, the feedstream may include the initial feedstock along with additional components, such as liquid and/or gas solvents or carriers, and/or recycled feedstock. In some arrangements, the fluidizing gas may also include catalyst gases.

In embodiments where the initial feedstock is primarily or entirely solid, initial feedstock may be provided in a flow rate of greater than 0 to about 20 g/hr, greater than 0 to about 500 g/hr, or greater than 0 to about 500 kg/hr. Such examples are exemplary in nature and appropriate feedstock flow rates may depend process and equipment conditions such as carrier gas flow rates and reactor size. For example, initial or total feedstock flow rates may be greater than 0 to about 20 g/hr for a reactor diameter of 0.5″ to 1.5″, greater than 0 to about 500 g/hr for a reactor diameter of 1.5″ to 3″, or greater than 0 to about 500 kg/hr for a reactor diameter of 5″ to 15″.

The catalyst can be any catalyst that converts the feedstock to hydrogen and includes earth abundant catalysts as well as designer catalysts. In some aspects, the earth abundant catalyst is a non-structured catalyst. In another aspect, the earth abundant catalyst is a structured catalyst. In some embodiments, the catalyst comprises an earth-abundant transition metal, such as one or more of Mn, Fe, Co, Ni, Cu, Ti, V, Cr, Zr, Nb or W.

In other embodiments, the catalyst is an oxide of a metal selected from the group consisting of Ni, Co, Fe, Cu, Ce, Zr, Al, Pt, Pd, Rh, Ru, Si, and Mg, and combinations thereof. In some embodiments, the catalyst is an oxide of a metal selected from the group consisting of Ni, Co, Fe, Cu, Ce, Zr, Al, Si, and Mg, and combinations thereof. In some embodiments, the catalyst is an oxide of a metal selected from the group consisting of Ni, Co, Fe, Cu, Ce, Zr, and Al and combinations thereof. In other embodiments, the catalyst is an oxide of a metal selected from the group consisting of Pt, Pd, Rh, and Ru and combinations thereof. In yet other embodiments, the catalyst is selected from the group consisting of iron oxides, supported iron, supported nickel, carbon, and iron carbides and combinations thereof.

In some embodiments, the catalyst comprises iron. In some aspects of this embodiment, the catalyst is selected from magnetite, bauxite, bauxite residual (also known as “red mud”), Fe, Fe₃C. FeO, Fe₂O₃, Fe₃O₄, and combinations thereof. In some aspects of this embodiment, the catalyst comprising iron is recovered from a prior iteration of the disclosed method and recycled so that it may be used again. Recycling and reusing the catalyst advantageously reduces natural resources from being mined and processed and lowers material and operational costs.

In various embodiments, the catalyst may be a natural mineral catalyst, such as dolomite or olivine. In other embodiments, the catalyst may be a supporting oxide selected from the group consisting of SiO₂, MgO, and ZrO₂.

In other possible arrangements, the catalyst comprises Ni/Al₂O₃ and/or Ni—Mg—Al. In other aspects, the catalyst further includes natural mineral catalysts, such as dolomite or olivine.

The catalyst may also include a compound selected from the group consisting of Al(NO₃)₃9H₂O, Ce(NO₃)₃6H₂O, ZrO(NO₃)₂×H₂O, NH₄HCO₃, and Ni(NO₃)₂6H₂O.

It should be understood that the particle size and surface area for any particular catalyst will depend on a variety of factors, including the type of catalyst, the amount of catalyst used, the catalyst to plastic ratio, the reaction conditions, temperature, carrier gas flow rate, and the apparatus design.

In some embodiments the catalyst may be provided in a flow rate of greater than 0 to about 1 g/hr, greater than 0 to about 100 g/hr, or greater than 0 to about 100 kg/hr. Such examples are exemplary in nature and appropriate catalyst flow rates may depend process and equipment conditions such as carrier gas flow rates and reactor size. For example, initial, recycled, or total catalyst flow rates may be greater than 0 to about 1 g/hr for a reactor diameter of 0.5″ to 1.5″, greater than 0 to about 100 g/hr for a reactor diameter of 1.5″ to 3″, or greater than 0 to about 100 kg/hr for a reactor diameter of 5″ to 15″.

In some embodiments, the solid content (inclusive of both a solid feedstock, solid catalyst, and solid product) flow rate may be the range of greater than 0 to about 21 g/hr, greater than 0 to about 600 g/hr, or greater than 0 to about 600 kg/hr. Such examples are exemplary in nature and appropriate solid flow rates may depend process and equipment conditions such as carrier gas flow rates and reactor size. For example, initial, recycled, or total solids flow rates may be greater than 0 to about 21 g/hr for a reactor diameter of 0.5″ to 1.5″, greater than 0 to about 600 g/hr for a reactor diameter of 1.5″ to 3″, or greater than 0 to about 600 kg/hr for a reactor diameter of 5″ to 15″., when the superficial velocity of carrier gas is within the range of 0.1 m/s to 10 m/s. Appropriate tailoring of solid content flow rate to carrier gas flow rate is important to ensure proper fluidization of the reactor bed, in order to successfully produce the hydrogen deficient carbon product.

In some aspects, the hydrogen deficient carbon product may include one or more types of carbon including graphite, graphene, carbon nanotubes (“CNTs”), amorphous carbon, carbon black, fullerenes, carbon fiber, glassy carbon, and the like. In some embodiments, the hydrogen deficient carbon product is a mixture of two or more types of carbon, including graphite, graphene, carbon nanotubes (“CNTs”), amorphous carbon, carbon black, fullerenes, carbon fiber, glassy carbon, and the like. In a preferred embodiment, the hydrogen deficient carbon product includes a carbon nanotube. In some embodiments, the carbon nanotube produced by the disclosed methods and reactors is a mixture of multi-walled and single-walled CNTs.

In one example, the reactor 100 stands upright as shown and an inert carrier gas is injected into the vessel from the bottom. A manifold composed of a distributor and a gas chamber (not shown in FIG. 2) is positioned at the bottom of the reactor. Carrier gas may be fed into the gas chamber through one or more gas lines, which may enter on the side and/or bottom of the upright reactor.

The distributor may be a plate with a plurality of apertures through which carrier gas is distributed into the reactor. Like the vessel itself, the distributor is adapted to withstand the temperatures of the reactor as well as the chemical reactions occurring within the reactor. The distributor may be ceramic or stainless-steel plate with perforations or may include a mesh. Besides distributing carrier gas into the vessel, the distributor is also configured to maintain the material within the vessel above the distributor and hence any apertures should be sufficiently sized to not allow the feedstock, catalyst and/or absorber within the vessel to fall below the distributor.

Carrier gas is injected into the gas chamber, which carrier gas may be under pressure and the gas is then distributed into the vessel through the distributor. In some embodiments, the carrier gas may be an inert gas such as N₂, CO₂, or any noble gas (He, Ar, etc.). In some embodiments, the carrier gas may be a reactive hydrocarbon such as methane, ethane, propane, butane, pentane, etc. In some embodiments, the carrier gas may be a dilute O₂. In various embodiments, the carrier gas may include a product gas or gas mixtures, and may include recycled gas. The carrier gas may be selected from the group consisting of nitrogen, argon, helium, water vapor, carbon dioxide, and air, and combinations thereof. In some embodiments, the carrier gas is selected from the group consisting of nitrogen, argon, water vapor, carbon dioxide, and air, and combinations thereof. In some embodiments, the carrier gas is selected from the group consisting of nitrogen, argon, and helium, and combinations thereof. In some embodiments, the carrier gas may also comprise recycled hydrocarbons. The carrier gas may be referred to as or considered a “fluidizing gas”. In some arrangements, the carrier gas is unheated (substantially room temperature) at the time that it is fed to the reactor.

It should be understood that the flow rate of the carrier gas may depend on a variety of factors, including the type of catalyst, the particle size of the catalyst used, the uniformity of the particle size of the catalyst used, the mass of the catalyst used, the size and density of the feedstock used, the ratio of the catalyst to feedstock, the size of the reactor, pressure, and the reaction conditions.

It is important that the carrier gas velocity be sufficient to fluidize the various solid and liquid materials entering the reactor vessel. Gas velocities are measured in meters per second (m/s). In different embodiments the fluidization velocity may vary between about 0.01 m/s to about 10 m/s.

The actual volumetric flow rate required to achieve the required fluidization velocities is a function of vessel diameter. When the size of the reactor is increased, for example, to one suitable for an industrial process, the flow rate is increased such that it is sufficient to fluidize the catalyst bed. Actual volumetric flow rate is measured in actual cubic centimeters per minute (ACCM). For any reactor vessel diameter, we can determine the ACCM. As noted herein, there is a wide range of possible vessel diameters. Correspondingly there will be a wide range of carrier gas volumetric flow rates required among the various possible reactor embodiments, with the following being examples and not intended to be limiting. For a 1 to 3 inch diameter reactor vessel the range may be approximately 1,000-1,200,000 ACCM. More specifically, for a 2 inch diameter reactor vessel the range may be approximately 1,000-1,200,000 ACCM. For a 8 to 12 inch diameter reactor vessel the range may be approximately 30,000-30,000,000 ACCM. More specifically, for a 10 inch diameter reactor vessel the range may be approximately 30,000-30,000,000 ACCM. Selection for appropriate flow rates for the diameter of vessel may allow for successful fluidization of the bed, even in cases with a solid feedstock.

The flow rate of the carrier gas will be dependent on many parameters. In various possible specific examples, the flow rate can be in the range of about 1,000 ACCM to about 30,000,000 ACCM (actual cubic centimeters per min). In some embodiments, the gas flow rate can be in the range of about 1,000 ACCM to about 1,200,000 ACCM, about 50,000 ACCM to about 1,200,000 ACCM, about 100,000 ACCM to about 1,200,000 ACCM, about 150,000 ACCM to about 1,200,000 ACCM, about 200,000 ACCM to about 1,200,000 ACCM, about 250,000 ACCM to about 1,200,000 ACCM, about 300,000 ACCM to about 1,200,000 ACCM, about 350,000 ACCM to about 1,200,000 ACCM, about 400,000 ACCM to about 1,200,000 ACCM, about 450,000 ACCM to about 1,200,000 ACCM, about 500,000 ACCM to about 1,200,000 ACCM, about 550,000 ACCM to about 1,200,000 ACCM, about 600,000 ACCM to about 1,200,000 ACCM, about 650,000 ACCM to about 1,200,000 ACCM, about 700,000 ACCM to about 1,200,000 ACCM, about 750,000 ACCM to about 1,200,000 ACCM, about 800,000 ACCM to about 11,200,000 ACCM about 850,000 ACCM to about 1,200,000 ACCM, about 900,000 ACCM to about 1,200,000 ACCM, or about 1,000,000 ACCM to about 1,200,000 ACCM. In some embodiments, the gas flow rate can be in the range of about 10 SCCM to about 30,000,000 ACCM, about 100,000 ACCM to about 30,000,000 ACCM, about 1,000,000 ACCM to about 30,000,000 ACCM, about 5,000,000 ACCM to about 30,000,000 ACCM, about 10,000,000 ACCM to about 30,000,000 ACCM, about 15,000,000 ACCM to about 30,000,000 ACCM, or about 20,000,000 ACCM to about 30,000,000 ACCM

The standard volumetric flow rate (or molar flow rate) of carrier gas required will be dependent on many parameters. The molar flow required to achieve the correct fluidization velocity is a function of system temperature, system pressure, and required volumetric flow rate. The required volumetric flow rate is in turn a function of vessel diameter and the required fluidization velocity. The range of each parameter, as mentioned, is broad, and there are many possible embodiments.

The vessel 102 may include one or more ports 104 through which material is introduced into the vessel 102. The one or more ports 104 may include some form of valve adapted to control feedstock distribution into the vessel 102, and may include a door at an inner wall of the vessel 102. One advantage of various aspects of the present disclosure is to provide continuous processing as opposed to a batch or other non-continuous process. As such, in some aspects, all materials (gas and solids) are continuously fed into the reactor 100. Similarly, the feedstock is converted into products and thus does not accumulate in the reactor 100. Gas products are removed out of the reactor 100 and carried to any downstream units (e.g. a separator) by carrier gas. Parts of solids (catalysts and products) are also continuously transported to other possible downstream units (e.g., a separator, a regenerator, etc.), and thus they do not accumulate in the reactor 100.

According to various aspects of the present disclosure, a transmission line assembly may couple microwave energy from one or more microwave generators 106 into the reactor vessel 102. In the embodiment of FIG. 1, four waveguides 108 are coupled to a sidewall of the vessel 102 and aligned in a vertical orientation. In the embodiment of FIG. 2, eight waveguide 108 are coupled to the sidewall of the vessel 102 with four of the waveguide 108 aligned vertically and an opposing four waveguide 108 also aligned vertically, and 180 degrees spaced from the first set of waveguides. In the example of FIG. 2, the opposing waveguides 108 are also vertically staggered. Waveguide 108 may also be vertically staggered and coupled in a helical pattern at 90 or 120 degree spacing or other possible arrangement depending on the size of the vessel 102, among other requirements. Generally speaking, multiple microwave transmission lines may be coupled with vessel at spacing determined by the penetration depth of the microwaves into the bed and spaced as needed to optimize performance of the bed. Without being bound by theory, the microwave generator(s) and waveguide(s) interact with the cylindrical shape of the vessel to allow for even heating of the reactor contents. Accordingly, in some aspects the number or microwave generators and/or waveguides may be increased as the system is scaled up with respect to one or more of carrier gas flow rate and/or vessel 102 diameter and/or length. Conversely, in some embodiments, the number of microwave generators and/or waveguides may be reduced as the systems is scaled down. For example, there may be three or less microwave generators and/or waveguides, two or less microwave generators and/or waveguides, or only a single microwave generator and/or waveguide, as appropriate based on reactor shape and size. In some embodiments, there may be two or three microwave generators and/or waveguides provided in line or staggered along the circumference of the vessel 102. In other embodiments, there may be only one microwave generator and waveguide coupled to the vessel 102.

In various embodiments, the microwave is applied at a frequency in a range of about 100 MHz to about 8 GHz. In some embodiments, the microwave is applied at a frequency in a range of about 1 GHz to about 8 GHZ, in a range of about 1 GHz to about 7 GHz, in a range of about 1 GHz to about 6 GHz, in a range of about 1 GHz to about 5 GHz, in a range of about 1 GHz to about 4 GHz, or in a range of about 1 GHz to about 3 GHz. In some embodiments, the microwave is applied at a frequency in a range of about 100 MHz to about 3 GHZ, in a range of about 200 MHz to about 3 GHZ, in a range of about 300 MHz to about 3 GHZ, in a range of about 400 MHz to about 3 GHZ, in a range of about 500 MHz to about 3 GHZ, in a range of about 600 MHz to about 3 GHZ, in a range of about 700 MHz to about 3 GHz, in a range of about 800 MHz to about 3 GHZ, in a range of about 900 MHz to about 3 GHZ, in a range of about 900 MHz to about 2.5 GHZ, in a range of about 900 MHz to about 2 GHz, in a range of about 900 MHz to about 1.5 GHZ, or in a range of about 900 MHz to about 1 GHz. In some embodiments, the microwave is applied at a frequency of about 2.45 GHz. In other embodiments, the microwave is applied at a frequency of about 915 MHZ.

In one embodiment, the microwave energy can be applied under continuous conditions, varying the power to maintain reaction temperature for whatever material is being processed. In another embodiment, the microwave is pulsed. In various arrangements, the system may be mono-mode or multi-mode. The time that carrier gas flows through the reactor 100 (more specifically, through the catalyst fluidized bed) is dependent on the reactor size and gas flow rates. This time should be sufficient to convert any entering feedstock into products. Otherwise, material may accumulate and de-fluidize the bed.

In embodiments in which the microwave is continuously applied, the processing time of the plastic is a time in a range of about 30 seconds to about 20 minutes. In some embodiments, the processing time is in a range of about 1 minute to about 10 minutes, about 2 minutes to about 10 minutes, about 3 minutes to about 10 minutes, about 4 minutes to about 10 minutes, about 5 minutes to about 10 minutes, about 6 minutes to about 10 minutes, about 7 minutes to about 10 minutes, about 8 minutes to about 10 minutes, about 9 minutes to about 10 minutes, about 30 seconds to about 10 minutes, about 30 seconds to about 9 minutes, about 30 seconds to about 8 minutes, about 30 seconds to about 7 minutes, about 30 seconds to about 6 minutes, about 30 seconds to about 5 minutes, about 30 seconds to about 4 minutes, about 30 seconds to about 3 minutes, or about 30 seconds to about 2 minutes. In some embodiments, the processing time is about 30 seconds, about 1minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, or about 15 minutes. Different feedstocks will have different processing times at temperature.

In some instances, the system may be used for graphitization of the feedstock or carbon byproducts.

Without being bound by theory, it is believed that, when the reaction vessel 102 and its contents (i.e. catalyst and feedstock) are be operated at a reaction temperature in a range from about 450°° C. to about 3000° C., more preferably about 600° C. to about 2000° C., or most preferably about 700° C. to about 1000° C., depending on various factors including the feedstock, catalyst, carrier gas flow rate, and reaction residence time, products containing elevated levels of solid carbons, and in particular solid carbons containing CNTs may be produced. In a particular preferred embodiment, the reaction temperature is within the range of about 650° C. and 750° C. If an inappropriate reaction temperature, e.g., a temperature outside of the disclosed ranges, is chosen, reaction may not proceed or may proceed inefficiently. For example, if too low a reaction temperature is used, the reaction may not proceed or may not proceed efficiently due to insufficient heating. Conversely, if too high a reaction temperature is chosen, this may decrease first pass hydrogen yield. Additionally, overly high temperatures may increase production cost by imposing additional energy requirements and/or necessitating specialized equipment suitable for high temperature conditions.

The waveguides 108 are shown as a rectangular cross-section but they may also be circular or other shapes. Additionally, while waveguides 108 are illustrated, it also possible to use an antenna, such as a strip antenna, to direct microwave energy into the vessel 102. Adjacent where the waveguide 108 is coupled to the vessel, a quartz window 116 may be provided. The quartz window 116 passes microwave energy while preventing material being processed within the vessel 102 from flowing beyond the quartz window 116 into the waveguide 108. The quartz window 116 may be temperature sensitive and hence it may be offset from the vessel sidewall. An iris may be positioned or otherwise integrated into the waveguide 108 where the waveguide 108 is coupled to the reactor vessel 102. The iris, if present, provides impedance matching to the reactor load. Additionally, a cooling sleeve 118 may be positioned at the quartz window 116, with such a cooling sleeve 118 shown positioned around the waveguide 108 between the vessel sidewall and the quartz window 116. The multiple (e.g., four or eight) microwave transmission lines entering the FBR vessel 102 in any particular implementation will be at spacing determined by the penetration depth of the microwaves into the bed and spaced as needed to optimize performance of the bed for the process of the bed.

A cooled transmission line section to promote condensation of any condensable gases and to remove the challenge of high temperature joints/seals is also provided.

The waveguides 108 may be coupled to the vessel 102 at various possible angles. As shown, the waveguides 108 are couple at a downward angle, which may be about 45 degrees to about 60 degrees, more preferably about 50 degrees to about 55 degrees, relative to the vessel sidewall, with other angular orientations possible. In some embodiments, the waveguides may be coupled at a perpendicular angle to the vessel 102. Coupled in such a way, any material that may flow upward into the waveguides 108 due to action of the fluidized bed may fall back out by way of gravity. In one possible implementation, inert gas may be coupled into the terminal waveguides 108 and positioned to flow gas into the vessel 102, which may help prevent some material from entering into the waveguide 108 and assist in clearing material from the waveguide 108.

In the example of FIG. 1, in some embodiments, microwave energy from a microwave generator 106 is provided to each terminal waveguide 108 by way of a first splitter that splits/divides the microwave energy into two channels formed of waveguides 108, which each being coupled with a pair of second splitters that further divide the microwave energy into two channels (each) and guide the microwave energy to the four terminal waveguides 108. In the example of FIG. 2, the arrangement is mirrored on the opposing side of the reactor vessel 102.

The reactor vessel 102 design is typically a metal cylinder with endcaps bolted on using a choke flange design. The outer cylinder wall can be at a much lower temperature than an inner quartz tube and insulation can be placed between the quartz and the cylinder. For higher temperatures where radiative heat transfer from the reactor tube to the cylinder is high, the insulation is more important. With proper insulation and/or relatively lower applications, the system may not be cooled. For higher temperatures, a water-cooler may be operably coupled with the outer reactor vessel wall.

In the embodiment of FIG. 2, a similar combination of microwave generator 106 and splitters 120 with distribution channels is shown on one side of the vessel 102, and a copy of combination on the other side of the vessel 102. So, in the second embodiment, microwave energy from two microwave generators 106 is evenly distributed to eight terminal waveguides 108 coupled into the vessel 102. In the embodiments shown, a microwave generator 106 is providing microwave energy to four waveguides 108 directing the divided microwave energy into the reactor vessel 102. In some instances, discrete microwave generators 106 may provide microwave energy to each waveguide 108 or other splitting arrangements are possible depending on the size (diameter and/or height), of the reactor vessel 102 and material being processed.

Microwaves may be introduced to the reaction vessel 102 through dielectric windows or through coaxial antenna structures which include a dielectric surface. In both cases, coating of the dielectrics, for instance, by carbonaceous by-products, will interfere with microwave transmission. Use of any dielectric for transmission may not include such a coating.

In one example, each of the terminal waveguides 108 ends as an open waveguide at the point where it joins the reactor vessel 102, but includes a fully occluding window, transparent to microwave transmission but blocking gas and particle flows from moving further upstream into the waveguide 108. Although there will be some movement of process gas and particles into the “dead-end” transmission line, the flow will be significantly reduced relative to the scenario where the waveguide 108 is open at both ends. This arrangement may avoid the challenges of sealing and window erosion that would result from having a window at the vessel wall while substantially capturing the advantages of eliminating catalyst loss and minimal disruption of the gas flow in the fluidized bed.

In some aspects, the reactor 100 and process may have one or more effluent streams. In some embodiments, the reactor 100 may have a mixed effluent stream. In some embodiments, the mixed effluent stream may exit the reactor 100 at the top of the vessel 102. In some aspects, the mixed effluent stream may include hydrogen gas, carbon containing gases (such as methane and ethylene), carbon dioxide, tars, pyrolysis oil, catalyst, and the hydrogen deficient carbon product. The mixed effluent stream may include products and byproducts in gas, liquid (condensable under normal conditions or 25° C. and 1 atm), or solid form, as well as, in some cases, catalyst which has been carried out of the reactor by flow of the carrier gas, products, and byproducts. In some embodiments, the mixed effluent stream contains less than 15% by weight liquid hydrocarbon, less than 10% by weight liquid hydrocarbon, less than 5% by weight liquid hydrocarbon, or no liquid hydrocarbon. In alternative embodiments, the mixed effluent stream may contain greater than 15% by weight liquid hydrocarbon, greater than 10% by weight liquid hydrocarbon, greater than 5% by weight liquid hydrocarbon, or no liquid hydrocarbon.

The mixed effluent stream may initially be separated into a mixed gas stream and a non-gas stream by any suitable methods such as physical separation, condensation, and filtration. Methods for separating solids from gases are well known in the art, and any suitable methods and apparatus may be used herein. Suitable devices for performing this separation include knock-out pot (sedimentation), cyclone separators, filtration (such as fiber media or membrane filtration), coalescers, and devices. In some embodiments, the mixed effluent stream may be separated into mixed gas and non-gas streams in a knockout drum.

The non-gas stream may include the hydrogen deficient carbon product, catalyst, and any non-gas byproducts such as pyrolysis oil. The hydrogen deficient carbon product may be separated from catalyst and/or any byproducts by any suitable method such as centrifugation. In some embodiments, recovered catalyst may be recycled to the reactor.

In some aspects, the hydrogen deficient carbon product is a mixture of solid, hydrogen deficient carbon forms including two or more of graphite, graphene, carbon nanotubes (“CNTs”), amorphous carbon, carbon black, fullerenes, carbon fiber, glassy carbon, and the like. In some embodiments, the hydrogen deficient carbon product contains at least 25% by weight CNTs, at least 30% by weight CNTs, at least 40% by weight CNTs, or at least 50% by weight CNTs. In some embodiments, the hydrogen deficient carbon product may contain 75% by weight graphite or less, 70% by weight graphite or less, 65% by weight graphite or less, or 50% by weight graphite or less. In some embodiments, the hydrogen deficient carbon product may include 95% by weight or more CNTs and graphite, 90% by weight or more CNTs and graphite, or 85% by weight or more CNTs and graphite, with the remainder being other carbon forms. In alternative embodiments, the hydrogen deficient carbon product may contain at least 25% by weight graphite, at least 30% by weight graphite, at least 40% by weight graphite, or at least 50% by weight graphite. In some embodiments, the hydrogen deficient carbon product may contain 75% by weight CNTs or less, 70% by weight CNTs or less, 65% by weight CNTs or less, or 50% by weight CNTs or less.

In aspects in which the hydrogen deficient carbon product is a mixture, particular components (e.g. CNTs) may be separated from the hydrogen deficient carbon product by suitable methods, such as centrifugation, sieving, gravity stratification, liquid sedimentation, and/or any other suitable methods known in the art.

According to some aspects, the reaction product may include the hydrogen deficient carbon product and hydrogen gas. In some embodiments, the reaction product may include at least 70% by weight or more solids, at least 75% by weight or more solids, at least 80% by weight or more solids, or at least 85% by weight or more solids. In some embodiments, the reaction product may include 30% by weight or less hydrogen gas, 25% by weight or less hydrogen gas, 20% by weight or less hydrogen gas, or 15% by weight or less hydrogen gas. In alternative embodiments, the reaction product may include 70% by weight or less solids, 60% by weight or less solids, 50% by weight or less solids, or 40% by weight or less solids. Without wishing to be bound by theory, the use of the particular disclosed reactors and methods utilizing microwave energy directed into a fluidized bed allow for the production of a reaction product containing increased levels of solid hydrogen deficient product, in contrast to conventional methods, which tend to produce higher levels of liquid hydrocarbon.

The mixed gas stream may then be further conveyed for gas separation through pressure swing adsorption, membrane gas separation, cryogenic separation, or any other suitable gas separation techniques. Inert gases may be separated and recycled as fluidizing gas provided into the vessel. Carbon containing gases may be separated and recycled as a supplemental feedstock to the reactor. Hydrogen gas may be harvested and not recirculated.

The system may also include one or more temperature sensors (not shown) configured to measure the temperature of the reactor. The temperature sensor detects the temperature of the fluidized bed materials so that processing may be optimized, and temperature and microwave energy controlled to for any given reaction occurring in the vessel 102.

FIGS. 3A and 3B illustrate a lower and upper section of a microwave-heated fluid bed reactor in a third arrangement. Referring first to FIG. 3A, the microwave-heated fluid bed reactor includes a preheat and initiation stage 300. In this stage, there are distinct ports 104 for introducing feedstock 302 and catalyst 304 into a lower vessel section. The embodiments shown in FIGS. 1 and 2 may similarly have more than one input port 104. The lower vessel section may be a cylindrical vessel. As shown, the vessel in this exemplary embodiment is 2 inches in diameter although other diameters are possible, and likely larger in a high-volume configuration. A distributor 112 including a distribution plate, like introduced above, is positioned in a lower portion of the vessel 102. The distribution plate maintains feedstock and catalyst (and/or distinct absorbers) above the distribution plate and allows carrier gas to be introduced below and pass through the distribution plate to initiate the fluidized bed.

The material input ports 104 including the catalyst ports 304 and the feedstock ports 302, are downwardly oriented to ensure that material passes downwardly into the vessel 102, and to assist return by gravity to the vessel 102 any material that flows into the ports 104 when the bed is active. The feedstock port 302 is shown with a heat exchanger 306. While in some embodiments, the heat exchanger 306 may be a heating sleeve, a heater, a cooling sleeve, a chiller, or any other type of suitable heat exchanger, as depicted in FIG. 3A, the heat exchanger 306 is a cooling sleeve, in the form of a chiller operably coupled to the port, and oriented at a 60 degree angle at the interface to the lower vessel. A gas purge line is coupled into the feedstock port to inject gas, which may be inert, to assist in distributing feedstock into the vessel 102. The catalyst port 304 may include a rotary valve 310 (as may the feedstock port 302) to allow catalyst to be selectively distributed into the vessel 102, and/or control the feed rate of material into the vessel 102. While not shown, a hopper or other storage may be couple with the input ports 104 to supply feedstock and catalyst, or other material, to the respective ports. The catalyst port 304 may also include purge gas. The purge gas of either port may be controlled to assist in controlling feedstock and catalyst into the lower vessel 102. While shown at a 45 degree downward angle, other downward orientations are also possible for the catalyst port 304. For both ports and for other discussed above, the ports may be perpendicular and there may be some mechanical and/or gas mechanisms to distributed material into the vessel 102.

A heater 308 may be operably coupled with the lower vessel to preheat material introduced into the lower stage. This may help with production throughput, thermal uniformity and/or possible lower temperature pretreatment of material in the lower vessel. In a pretreatment step, there may be some amount of dwell time at the lower temperature as well as a gas purge line at the top of the lower vessel to remove or separate any gases from the lower temperature pretreatment stage. The lower vessel may also include a plate 312 between the lower stage and an upper stage, discussed in more detail below, to separate any production gases or other intermediate outputs formed in the lower stage from the upper stage.

Regardless, the lower stage is fluidly coupled with the upper stage, which includes a microwave heated fluidized bed reactor vessel. As shown, the lower vessel is a cylinder and the upper stage may similarly include a cylinder with a matching internal diameter (as shown a 2 inch quartz tube). In operation, the fluidized bed may be initiated in the lower stage and the material flows up into the upper stage vessel where it is heated to higher temperatures by way of microwaves.

The coupling between the upper vessel and the lower vessel, or between the upper vessel and any downstream processing sections may include graphite fittings, flanges and/or gaskets due to the use of microwaves in the fluidized bed reactor vessel as well as the possibility of high temperature and/or pressure gradients between the reactor vessel and input and/or output systems suppling material, gas and the like to the reactor vessel or receiving product gases or product solids from the reactor vessel.

In the example shown and referring to FIG. 3B, the quartz reactor vessel tube 314 is transparent to microwaves and it is positioned within a microwave multimode cavity 316. So, the carrier gas injected into the lower vessel initiates the flow of material upward into the reactor vessel 102 where the material is heated in the fluid bed. Unlike the embodiments of FIGS. 1 and 2, here the microwave energy is transferred to the material in the vessel by positioning the quartz reactor quartz reactor vessel tube 314 within the cavity. One or more microwave generators 106 are operably coupled with cavity, which may be by way of waveguides 108, and the microwave energy is introduced within the cavity. The microwave energy, like discussed above relative to the embodiments of FIGS. 1 and 2, heats the material in the upper vessel. Hydrogen gas or any other output products are removed at the top of the upper vessel.

In any of the embodiments, the reactor vessel 102 may include one or more viewing ports, which may be operably connected with a camera or cameras or imaging systems to view what is occurring in the reactor 100. Similarly, one or more temperature probes may be coupled with the vessel to monitor temperature at various discrete points with the vessel or within the vessel generally.

In various embodiments, insulation may be provided around the vessel 102 or vessels 102, around various input ports or other connection points to the vessel(s).

It is to be understood that this invention is not limited to the particular example apparatuses, methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

What is claimed:

1. A reactor comprising:
a vertically oriented vessel including a gas inlet port configured to provide a carrier gas to an interior of the vessel;
a distributor operably coupled with a lower portion of the vessel, the distributor adapted to distribute the carrier gas into the interior of the lower portion of the vessel;
a feedstock port arranged to continuously provide a carbon feedstock into the interior of the vessel; and
a microwave generator operably coupled with the vessel and configured to inject microwave energy into the interior of the vessel.

2. The reactor of claim 1 wherein the vessel is cylindrical.

3. The reactor of claim 1, wherein the vessel contains a fluidized bed.

4. The reactor of claim 1, wherein the port is operably coupled with the vessel above the distributor.

5. The reactor of claim 1, wherein the microwave generator is operably coupled with the cylindrical vessel by way of a waveguide.

6. The reactor of claim 5, wherein the waveguide includes a first plurality of waveguides, each of the first plurality of waveguides being vertically separated and operably coupled with the cylindrical vessel.

7. The reactor of claim 5, wherein the waveguide includes a second plurality of waveguides, each of the second plurality of waveguides being vertically separated and operably coupled with the cylindrical vessel, and
wherein the second first plurality of waveguides is spaced 180 degrees from the first plurality of waveguides, around a circumference of the vessel.

8. The reactor of claim 7, wherein the second plurality of waveguides are also vertically spaced relative to the first plurality of waveguides.

9. The reactor of claim 5, wherein the waveguide comprises a gas feed adapted to allow gas to be fed into the waveguide to blow processed solid material out of the waveguide.

10. The reactor of claim 5, wherein the microwave generator is operably coupled with the vessel by way of the waveguide at a downward angle and including an aperture into the cylindrical vessel.

11. A method of producing a hydrogen deficient carbon product, comprising:
providing a reactor comprising:
a vertically oriented vessel including a gas inlet port configured to provide a carrier gas to an interior of the vessel;
a distributor operably coupled with a lower portion of the vessel, the distributor adapted to distribute the carrier gas into the interior of the lower portion of the vessel;
a feedstock port arranged to continuously provide a carbon feedstock into the interior of the vessel; and
a microwave generator operably coupled with the vessel and configured to inject microwave energy into the interior of the vessel;
feeding the carrier gas to the reactor via the gas inlet port, to form a fluidized bed;
feeding a solid plastic initial feedstock to the reactor via the feedstock port;
applying microwave energy into the vessel using the microwave generator; and
converting the solid plastic initial feedstock into the hydrogen deficient carbon product.

12. The method of claim 11, wherein the conversion of the solid plastic initial feedstock into the hydrogen gas and the solid hydrogen deficient carbon product comprises raising a temperature of the solid plastic initial feedstock from a feed temperature to a reaction temperature.

13. The method of claim 12, wherein the feed temperature is within a range of 20° C. to 25° C.

14. The method of claim 12, wherein the reaction temperature is within a range of 450° C. to 3000° C.

15. The method of claim 14, wherein the reaction temperature is within a range of 650° C. to 750° C.

16. The method of claim 11, wherein the microwave energy is applied at a frequency in a range of about 100 MHz to about 8 GHz.

17. The method of claim 11, wherein a processing time is 30 seconds to about 20 minutes.

18. The method of claim 11, further comprising providing a catalyst within an interior of the vessel.

19. The method of claim 11, wherein the solid hydrogen deficient carbon product includes a carbon nanotube.
